(19) United States
(12) Patent Application Publication
(10) Pub. No.: US 2023/0258494 A1
(43) Pub. Date: Aug. 17, 2023

(54) PROTECTION MONITORING SYSTEM FOR LONG INFRASTRUCTURE ELEMENT, PROTECTION MONITORING DEVICE, PROTECTION MONITORING METHOD, AND STORAGE MEDIUM FOR STORING PROTECTION MONITORING PROGRAM

(71) Applicant: NEC Corporation, Minato-ku, Tokyo (JP)

(72) Inventors: Yutaka Yano, Tokyo (JP); Hiroshi Kawakami, Tokyo (JP); Makoto Saitoh, Tokyo (JP)

(73) Assignee: NEC Corporation, Minato-ku, Tokyo (JP)

(21) Appl. No.: 18/012,341

(22) PCT Filed: Jun. 28, 2021
(86) PCT No.: PCT/JP2021/024278

§ 371 Date: Dec. 22, 2022

(30) Foreign Application Priority Data
Jun. 29, 2020 (JP) 2020-111523

(51) Int. Cl. G01H 9/00; G08B 25/00

(52) U.S. Cl. CPC G01H 9/004; G08B 25/00

(57) ABSTRACT

In order to provide a protection monitoring system that comprises a warning function to which it is not easy to become habituated, and that can call attention at the time when abnormal vibration is sensed even without a cable undergoing failure, the protection monitoring system according to an embodiment of the present invention comprises an optical fiber provided along a long infrastructure element installed in water or on a seabed, an interrogator for acquiring environment information at positions along the long infrastructure element using the optical fiber, an abnormal event detection means for detecting an abnormal event around the positions when the environment information acquired at the positions satisfies an abnormality pattern provided in advance, and a notification means for issuing a notice to a ship positioned in a prescribed range from a position in which the abnormal event is detected.

### TECHNICAL FIELD

The present disclosure relates to a protection monitoring system and the like for a long infrastructure element, the protection monitoring system and the like using an optical fiber laid along a target object.

### BACKGROUND ART

Today, a submarine communication cable is widely used, and is regarded as an important infrastructure element. An action of damaging a submarine communication cable by intention or negligence is subject to punishment under the international laws (see, for example, Article 113 in NPL 1). The same is applied to a submarine pipeline and a submarine power transmission cable.

It is estimated that approximately 70% of damaged submarine communication cables are caused by fishing activities or anchors of marine vessels. In order to prevent such an “incident”, first, a location of a submarine cable is included in a nautical chart, and thus a sharing user of the ocean is notified of an accurate route for attracting his/her attention. Moreover, at some locations, a periphery of a submarine cable is designated as a submarine cable protection sea area (corridor) where activities such as anchoring and drilling are restricted. Despite of all those measures, occurrence of submarine communication cable damage incidents has not been sufficiently reduced yet.

When a length of a period is limited, there may be adopted, as a security method, a method of calling an attention of a marine vessel approaching a submarine cable from a chartered patrol boat. Further, there may be adopted a method of calling an attention by, when a marine vessel approaches a submarine cable, displaying a periphery of the submarine cable in a high-lighted manner in an electronic nautical chart display system to be referred to by the marine vessel at a time of steering. Further, there may be adopted a method of calling an attention of a marine vessel approaching a submarine cable through radio communication and the like by utilizing a marine vessel location information service such as an automatic identification system (AIS). A large-sized marine vessel has been required to install the AIS since 2002 by the International Convention for the Safety of Life at Sea (SOLAS convention), which is led by the International Maritime Organization (IMO), and the AIS is now a widely-spread nautical route information notification system for a marine vessel. Further, as a means for monitoring whether an object hits against a submarine cable, techniques in PTL 1 and PTL 2 are disclosed, for example.

Fishing activity information described later contains information that is provided by a fishery organization interested in interference avoidance between a submarine cable and fishing activities and relates to a fishing area and period in which interference with the cable may occur when the activities take place in a wrong location, and further contains information that relates to an individual identification number or the like provided to a boat performing such fishing activities.

Peripheral operation information described later contains information relating to an area and a period in which ocean construction work such as dredging, drilling, construction and recovery of a submarine cable, installation of a fishing bank, oceanographic surveys such as echo sounding submarine measurement and geological surveys, and the like take place, and further contains information that relates to an individual identification number or the like provided to a boat performing such operations.

Waterway report/navigational warning information described later is information that may contain the peripheral operation information described above in some cases, and is information that contains, in addition thereto, information relating to an area and a period in which a military drill or the like takes place, information relating to a drifting object, and the like.

### [Optical Fiber Sensing Technique]

Optical fiber sensing is, for example, a technique of causing coherent light to enter a sensing optical fiber, detecting and analyzing return light from each part of the sensing optical fiber, and acquiring, as the environment information, a disturbance (dynamic distortion) acting on the sensing optical fiber. Such a disturbance is typically a vibration of the sensing optical fiber, which is caused by an acoustic wave or the like transmitted to a part of the sensing optical fiber. When information indicating presence of a vibration in at least a part of the sensing optical fiber is acquired as the environment information, such optical fiber sensing is referred to as distributed acoustic sensing (DAS).

For example, the DAS technique is disclosed in PTL 3, PTL 4, NPL 2, and the like. DAS is one of OTDR-type sensing methods. Herein, OTDR is an abbreviation for optical time-domain reflectometry.

FIG. 1 is an explanatory diagram of an operation of a general OTDR-type optical fiber sensing system. The upper part schematically illustrates a main configuration of the sensing system, and the lower part schematically illustrates a power level according to a distance of probe light and backscattering light thereof and a state in which the probe light and the backscattering light thereof move along an elapse of time.

As illustrated in FIG. 1, the OTDR-type optical fiber sensing system includes an interrogator 100 and an optical fiber 200. The interrogator 100 transmits probe light 900 to the optical fiber 200 being a sensing optical fiber. The probe light 900 moves to the right side through the optical fiber 200, and backscattering light such as backscattering light 801, 802, and the like is generated at each position on the optical fiber 200 in a process of the moving. The backscattering light is typically Rayleigh backscattering light. The backscattering light moves to the left side through the optical fiber 200 toward the interrogator 100, and enters the interrogator 100. The backscattering light generated at each position on the optical fiber 200 is influenced by an environment surrounding the position. For example, the environment is a temperature at the position or presence of a vibration such as a sound.

The interrogator 100 detects a degree of influence received by the backscattering light being return light at each position on the optical fiber 200.

Then, the interrogator 100 derives environment information relating to an environment at each position on the optical fiber 200, from the information detected from the return light. For example, the environment information is information indicating a vibration condition of the optical fiber 200.

### CITATION LIST

### [Patent Literature]

[PTL 1] Japanese Patent No. 1619435

[PTL 2] Japanese Patent No. 3127934

[PTL 3] GB Patent No. 2126820

[PTL 4] Japanese Unexamined Patent Application Publication No. 10 S59-148835

[PTL 5] U.S. Pat. No. 10466172

### [Non Patent Literature]

[NPL1] UNITED NATIONS CONVENTION ON THE LAW OF THE 15 SEA, [online], retrieval date: Jan. 25, 2020, the Internet <https://www.un. org/Depts/los/convention agreements/texts/unclos/closin dx. htm>

[NPL 2] R. Posey Jr, G. A. Johnson and S. T. Vohra, “Strain sensing based on coherent Rayleigh scattering in an optical fibre”, ELECTRONICS LETTERS, 28 Sep. 2000, Vol. 36 No. 20

[NPL 3] G. Marra et al., “Ultrastable laser interferometry for earthquake detection with terrestrial and submarine cables”, Science 3 Aug. 2018: Vol. 361, Issue 6401, pp. 486-490

### SUMMARY OF INVENTION

### [Technical Problem]

As described in the section of Background Art, there is no method for constantly monitoring a long infrastructure element such as a submarine cable and calling an appropriate attention, and hence an incident causing damage cannot sufficiently be reduced. For example, in the method of calling an attention through radio communication every time a marine vessel approaches a submarine cable by utilizing marine vessel location information as in the AIS, an attention is called merely by passing near the periphery, and hence a marine vessel gets habituated to the warning, which causes a problem of reducing an effect of preventing a damage incident.

The present invention has been made in view of the above-mentioned problem, and an object of the present invention is to provide a protection monitoring system, a protection monitoring device, and a protection monitoring method that include a warning function causing less habituation to a warning and are capable of calling an attention at a time of detection of an abnormal vibration, which may not lead to a failure of a cable.

### [Solution to Problem]

A protection monitoring system according to the present invention includes an optical fiber being provided along a long infrastructure element installed in the water or the bottom of the water, an interrogator that acquires environment information at each position on the long infrastructure element through use of the optical fiber, an abnormal event detection means for detecting an abnormal event in a periphery of the each position when the environment information acquired at the position satisfies an abnormal pattern provided in advance, and a notification means for issuing a notification for calling an attention of a marine vessel located within a predetermined range from the position at which the abnormal event is detected.

A protection monitoring device according to the present invention includes an interrogator that acquires environment information at each position on a long infrastructure element installed in the water or the bottom of the water through use of an optical fiber provided along the long infrastructure element, an abnormal event detection means for detecting an abnormal event in a periphery of the each position when the environment information acquired at the position satisfies an abnormal pattern provided in advance, and a notification means for issuing a notification for calling an attention of a marine vessel located within a predetermined range from the position at which the abnormal event is detected.

A protection monitoring method according to the present invention includes acquiring environment information at each position on a long infrastructure element installed in the water or the bottom of the water through use of an optical fiber provided along the long infrastructure element, detecting an abnormal event in a periphery of the each position when the environment information acquired at the position satisfies an abnormal pattern provided in advance, and issuing a notification for calling an attention of a marine vessel located within a predetermined range from the position at which the abnormal event is detected.

A storage medium according to the present invention stores a protection monitoring program causing an information processing device to execute processing of acquiring environment information at each position on a long infrastructure element installed in the water or the bottom of the water through use of an optical fiber provided along the long infrastructure element, processing of detecting an abnormal event in a periphery of the each position when the environment information acquired at the position satisfies an abnormal pattern provided in advance, and processing of issuing a notification for calling an attention of a marine vessel located within a predetermined range from the position at which the abnormal event is detected.

### [Advantageous Effects of Invention]

According to the above-mentioned aspects, there can be exerted an effect of providing a protection monitoring system, a protection monitoring device, a protection monitoring method, and a storage medium that include a warning function causing less habituation to the warning and are capable of calling an attention at a time of detection of an abnormal vibration, which may not lead to a failure of a cable.

### BRIEF DESCRIPTION OF DRAWINGS

FIG. 1 is an operation explanatory diagram of a general OTDR-type optical fiber sensing system.

FIG. 2 is a block diagram illustrating a configuration of a protection monitoring system according to a first example embodiment.

FIG. 3 is an explanatory diagram of an algorithm for determining a marine vessel subjected to the warning in a first example of the first example embodiment.

FIG. 4 is a conceptual diagram illustrating a processing flow example in the first example of the first example embodiment.

FIG. 5 is an explanatory diagram of an algorithm for determining a marine vessel subjected to the warning in a second example of the first example embodiment.

FIG. 6 is a conceptual diagram illustrating a processing flow example in the second example of the first example embodiment.

FIG. 7 is an explanatory diagram of an example of an abnormal event caused by a sound or a vibration.

FIG. 8 is a conceptual diagram illustrating a processing flow example of a protection monitoring system according to a third example embodiment.

FIG. 9 is a conceptual diagram illustrating a processing flow example of the protection monitoring system according to the third example embodiment.

FIG. 10 is a block diagram illustrating a configuration example of a protection monitoring system according to a fourth example embodiment.

FIG. 11 is a flowchart illustrating an operation example of the protection monitoring system according to the fourth example embodiment.

### EXAMPLE EMBODIMENT

Example embodiments of the present invention are described below with reference to the drawings. Note that omission and simplification are made in the following description and drawings for clarifying the description. Further, in each of the following drawings, identical elements are denoted with identical reference symbols, and redundant description is omitted as required.

### First Example Embodiment

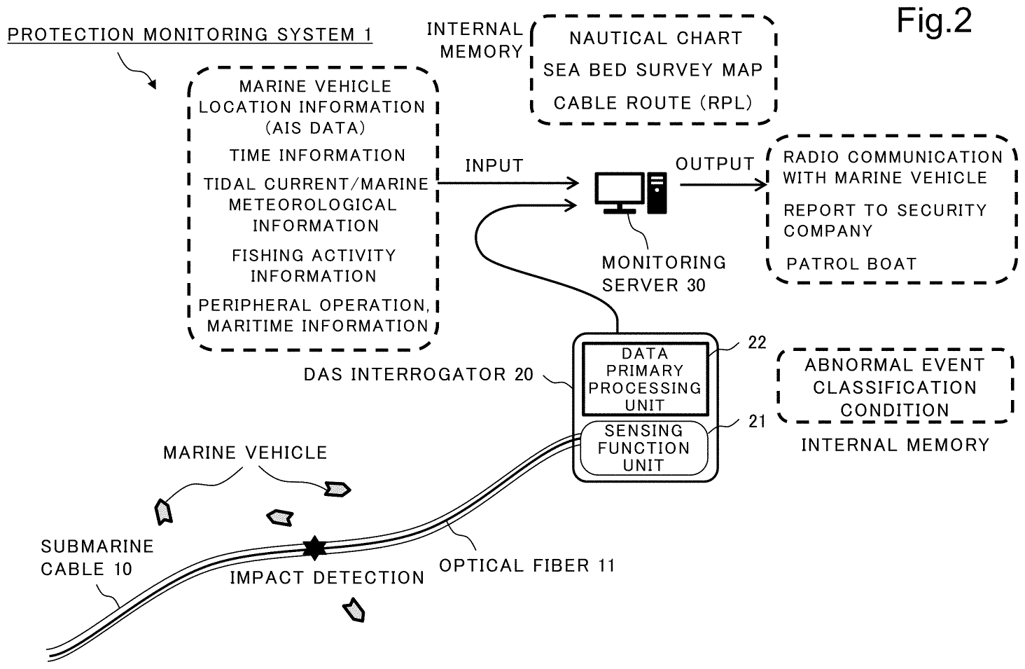

First, with reference to FIG. 2, description is made on a configuration example of a protection monitoring system 1 for a long infrastructure element according to a first example embodiment. In the present example embodiment, description is made while regarding a submarine cable 10 (hereinafter, also referred to as a cable) as a target object subjected to protection monitoring. Note that the target object may be a communication cable, a power transmission cable, a pipeline, and the like.

The protection monitoring system 1 at least includes the submarine cable 10 subjected to monitoring, a DAS interrogator 20 that uses an optical fiber 11 provided to the submarine cable 10 and performs sensing of peripheral environment information of the submarine cable 10 (in general, a sound, a vibration, or a temperature applied to the cable), and a monitoring server 30.

The DAS interrogator 20 (also referred to as an interrogator 20) includes a sensing function unit 21 and a data primary processing unit 22. The outline of the DAS technique is as described in the section of Background Art. The optical fiber 11 is accommodated inside the submarine cable 10 to which coating is applied for mechanical reinforcement. Further, the optical fiber 11 may be laid along the submarine cable 10 being a target object subjected to failure prediction. The optical fiber 11 functions as a sensor function and a transmission medium of a sensing signal.

The sensing function unit 21 sequentially receives backscattering light generated at each point of the long optical fiber 11, and outputs a sensing signal containing environment information at each point. The environment information may indicate, for example, a sound, a vibration, a temperature, or a change thereof over time.

The sensing signal indicating those factors is output to the monitoring server 30, and data particularly having an enormous data amount such as a sound and a vibration is output to the monitoring server 30 after the data primary processing unit 22 performs classification as an abnormal event and reduces the data amount. For example, when the environment information satisfies a predetermined condition, the data primary processing unit 22 performs classification as an abnormal event. In this sense, the data primary processing unit 22 is an example of an abnormal event detection means. Herein, all the events detected by the data primary processing unit 22 are referred to as abnormal events.

The monitoring server 30 at least includes information relating to an installation location (geographical coordinates) of the submarine cable 10 subjected to monitoring, a type of the submarine cable 10, an installation mode (laying on the surface, laying under the surface, presence or absence of an additional protective pipe) of the submarine cable 10, and the like (those are referred to as a route position list (RPL)) and a peripheral map (nautical chart) thereof.

Further, information from the interrogator 20 and information relating to a periphery of the target object subjected to protection monitoring from another system or a community are at least input to the monitoring server 30. Examples of such information include marine vessel location information (for example, AIS), time information, tidal current/marine meteorological information, fishing activity information, peripheral operation information, and waterway report/navigational warning information. Those pieces of information are acquired in various ways, for which description is omitted, and the monitoring server 30 is configured to receive those pieces of information automatically or semi-automatically through the Internet or the like. In this sense, the monitoring server 30 is an example of a marine vessel location information acquisition means.

Further, for example, the monitoring server 30 includes, as a means for outputting information, a notification means using radio communication with a marine vessel present in the periphery of the target object subjected to protection monitoring, a notification means for a public institution or a private security company that owns a patrol boat, or a notification means for a relevant person such as an owner of the target object subjected to monitoring. In this sense, the monitoring server 30 is an example of a notification means.

### [Non-Uniformity of Sensor Characteristics: Differences in Cable Types and the Like and Compensation]

Cable types or installation construction methods of the submarine cable 10 through which environment information is acquired differ according to an installation location. Thus, sensor characteristics of the submarine cable 10 differ according to a location. For example, an attenuation degree of a specific frequency range in a signal containing acquired environment information differs. It is desired that compensation processing of removing an influence therefrom and restoring an original signal be executed in such a way that the data primary processing unit 22 described later acquires an event classification result with higher reliability.

Herein, differences in cable types indicate, for example, differences in cross-sectional structures due to a power transmission purpose or a communication purpose, differences in protection coating structures (presence or absence of an armored wire and a type thereof), and the like. Differences in installation construction methods indicate differences between, for example, a construction method of merely placing a cable on the surface of the sea bed, and a construction method of digging a trench in the sea bed and burying a cable therein.

Those differences due to cable locations can be grasped with reference to a manufacturing record or a construction record (for example, the RPL), and hence can be compensated substantially uniquely for each location on the submarine cable 10. As a specific compensation method, for example, a filter is used to increase an amplitude of a specific frequency range.

Note that there may be adopted a method of subjecting a classification condition, which is described later, to such compensation instead of the acquired data. For example, when characteristics that a high frequency in the environment information is attenuated according to a cable structure are seen, a high frequency in the classification condition is attenuated according to a cable type of an acquired location without subjecting the acquired data to compensation, and thus more consistent pattern identification is easily acquired. However, it is preferred to subject the acquired data to compensation because versatility of data usage is improved when the acquired data is subjected to compensation, which is advantageous.

### [Non-Uniformity of Sensor Characteristics: On-Site Differences and Calibration]

What causes variation of sensor characteristics at each point of the laid submarine cable 10 cannot be determined (estimated) uniquely based on the above-mentioned construction record or the like. For example, even when the record indicates that burying is performed at a constant depth, a burying depth varies for each location or covering sand is washed away to cause exposure in actuality.

As a method for dealing with this problem, it is conceived to use a sound transmitted in a wide range on site as a reference and perform calibration. As a reference sound, an artificial sound or a sound generated naturally may be used. The same sound is sensed at each point of the submarine cable 10, and hence compensation is performed for each point in such a way to acquire a closely identical sound or a close value according to a distance from a sound source.

Further, with this calibration, it is possible to grasp whether each point of the submarine cable 10 is suitable for acquiring target environment information. For example, a sensing degree at one point is so low that compensation cannot be performed sufficiently, or another point so easily resonates in a specific frequency range that compensation cannot be performed easily. Such points at which environment acquisition is relatively difficult can be extracted by comparison of a moving average trend over time. In view of this, at the time of event detection classification in a later step, those points with difficulties are removed in consideration of an observation point distribution, data from a point at which substantially average environment information is seemingly acquired is used, and thus observation performance can be improved.

### [Addition of Geographical Coordinate Information]

The environment information acquired through the processing described above may be used for various purposes. Thus, it is required that the acquisition location be expressed with geographical coordinates. At the stage of the sensing data output from the sensing function unit 21, the acquisition location is expressed with a location on the cable (for example a distance from a cable end). The location on the cable and geographical coordinate data that is described in the construction record (for example, the RPL) and indicates a cable location are compared with each other, and thus geographical coordinates for each location on the cable are determined. The associated relationship between the location on the cable and the geographical coordinates does not change after cable installation, and hence may be calculated and stored in the interrogator in advance. Further, at this point, it is desired that water-depth (altitude) data be cited from the RPL and be included in the geographical coordinate information.

Further, before detecting and analyzing an abnormal event from the sensing data, the data primary processing unit 22 adds, to an individual piece of the data, the geographical coordinate information associated with the location on the cable.

### [Event Detection and Classification Functions]

Various events are included in the acquired environment information, and hence it is required to extract a noteworthy event among those as thoroughly as possible and as less erroneous detection as possible. In the present example embodiment, an event to be detected is, for example, a vibration generated when a certain object is brought into contact with a cable, a vibration generated when a heavy object is towed on the sea bed, a vibration generated when a heavy object touches a ground near a cable, a sound generated when an anchor chain is drawn out from a boat, and the like. Meanwhile, it is required to suppress erroneous detection of an on-boat machine sound of a boat, an earthquake, or the like as an event having a cable damage risk and calling an attention of a peripheral marine vessel as much as possible.

Note that the following description is made while assuming that handling of non-uniformity of sensor characteristics at each cable point and addition of the geographical coordinate information, which are described above, are all completed before detection and classification of an event.

The data primary processing unit 22 accurately detects and classifies a sound having a cable damage risk, which emerges in normal sounds. For this purpose, the data primary processing unit 22 is provided with characteristics unique to each of a plurality of known abnormal events as a classification condition in advance. The characteristics used in the classification condition are characteristics residing in a frequency of an abnormal event signal, a frequency change over time, a change of an intensity envelope curve over time, and the like. Further, as a classification method, techniques such as analogy determination, pattern identification, and machine learning may be used in combination.

Further, it is desired that the processing of detection and classification involve evaluation for each frequency band. Those details are described later.

The data primary processing unit 22 examines whether the acquired environment information includes a known abnormal event through comparison with the classification condition, and outputs, to the monitoring server 30, abnormal event data at least indicating an associated abnormal event type and an occurrence time, and location when a known abnormal event is included. According to an abnormal event type, information accompanying detection intensity (for example, a magnitude of vibration) is also output.

### [Event Classification Condition]

The event classification condition is prepared in such a way that an event is accurately detected and classified even when an installation condition of the submarine cable 10 differs. In the classification method, characteristics that are less affected by a cable installation condition and are present only at the time of abnormality are found, and classification is performed based on such characteristics. Even when an identical event cannot be accurately classified based on one classification condition due to an installation condition of the submarine cable 10, it is only required that the identical event be detected with any one of a plurality of classification conditions and be associated with an identical event type.

### [Method for Acquiring Accurate Classification Condition]

It is important to acquire a large number of pieces of case data relating to a normal sound and an abnormal sound, identify characteristics present only in an abnormal sound, and set the characteristics as a classification condition in advance, and thus a classification reliability degree is improved. When the number of pieces of case data is not sufficient, it is desired by simulating normal and abnormal events, the submarine cable 10 installed under various circumstances acquire a sound and a vibration generated therefrom, and a classification condition with a higher reliability degree be acquired.

For example, the data primary processing unit 22 regards environment information acquired at the time of a cruise of a marine vessel as a normal pattern, and extracts various cases according to a type, a speed, and the like of a marine vessel. Further, environment information acquired at the time of towing of an anchor, a weight, a trawl fishing tool, or the like is regarded as an abnormal pattern, and various cases according to a towing speed, a substratum condition, and the like are extracted. Further, characteristics that are hardly included in a normal pattern and are commonly shared in a specific type of an abnormal pattern are extracted, and are set as a detection/classification condition for the abnormal event of this type.

[Detection and Classification with Acquired Information in Frequency Band]

At the time of detecting and classifying the environment information, it is desired that the data primary processing unit 22 perform detection and classification after filtering the environment information according to frequency band regions. It is determined whether filtered data in each band region includes an event, based on the classification condition. Sorting is performed by dividing a frequency band region into a band region from an extremely low frequency to 0.01 Hz, a band region from 0.01 Hz to 0.1 Hz, a band region from 0.1 Hz to 1 Hz, a band region from 1 Hz to 10 Hz, and a band region from 10 Hz to 100 Hz, for example. However, it is desired that the band regions overlap with each other to some degree, and thus omission of detection of an event present near a boundary between the band regions can be prevented. Note that an abnormal event may be classified and determined based on a combination of detection results in a plurality of frequency bands.

When a signal that is not required to be detected but has a large amplitude is simultaneously present with a signal to be detected, those signals can possibly be separated from each other in terms of a frequency by detecting and classifying the environment information data filtered according to frequency bands. With this, detection and classification with a higher reliability degree can be achieved.

Further, a data size largely differs according to a frequency band, and hence arithmetic processing such as pattern identification is facilitated when filtering is performed according to a frequency band, which is advantageous.

Herein, the original sensing data (before filtering according to a frequency band) including an event detection part may also be output to the monitoring server 30 and be recorded regardless of whether an event classification function unit 23 uses the data. For example, such data can be utilized later at the time of a detailed analysis (off-line). It is desired that combination and parameters are programable as described above in such a way that detailed settings for operations are performed according to usage purposes and conditions.

### [Identification and Tracking of Identical Sound Source]

A sound or a vibration generated at a location away from a cable propagates in a concentric circular manner or a spherical manner, and is detected at a plurality of locations on the cable. In view of this, it can be estimated and identified that the sound is generated from one sound source by further analyzing geographical coordinates and time information relating to the detected event. With this, even when abnormal events having the same sound source are detected at the plurality of points on the cable, it is ideal to collectively output such events as one abnormal event to the monitoring server 30.

Further, in a case in which a sound source moves, estimation and identification are continuously performed, and thus grasping of a speed and a travel direction of the sound source and prediction of the slight future can be achieved. Moreover, when a model in which a sounding object moves is fed to the data primary processing unit 22, and comparison with the model is performed, identification and tracking can be performed.

As an example, it is assumed that an otter trawl fishing tool advances on the sea bed slightly away from the submarine cable 10 while being brought into contact with the sea bed. The data primary processing unit 22 includes a characteristic pattern of a vibration generated when an otter trawl fishing tool travels in contact with the sea bed, as a classification condition in advance. The data primary processing unit 22 detects a feature pattern of a vibration generated when an otter trawl fishing tool advances on the sea bed, from an acquired sensing signal output at a plurality of points on the cable. The detected geographical coordinates of each cable point, the detection time, and the detection intensity are analyzed from a classified event type, and are applied to a model in which a sound and a vibration arrive from the same sound source. As long as an event is kept detected, an object generating a sound and a vibration is tracked down.

Through application to a model of a moving object, a subsequent location to be detected can be predicted based on history in the past. In view of this, for example, automatic setting can be performed in such a way that a subsequent location predicted to be detected is further examined in detail in a spatial and temporal manner. Further, at a subsequent location where an event of a similar type is highly likely to occur, reliability of detection and classification can further be improved by, for example, lowering a detection threshold value for the event.

Such processing for identification and tracking of the same sound source may similarly be executed not only for a sound in the water but for a vibration propagating through the sea bed floor. The optical fiber 11 acquires environment information in which both the factors are mixed, but alternatively, both the factors may be separated away from each other according to a frequency or a transmission speed, and be analyzed.

The detection/classification function of the protection monitoring system 1 is as described above. In the following description, an output of the protection monitoring system 1, which is based on the detected and classified information, is described with two examples.

### FIRST EXAMPLE

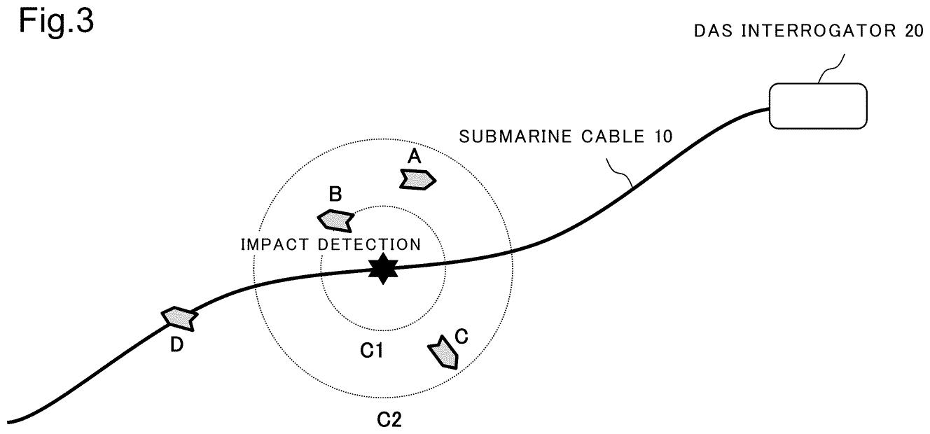

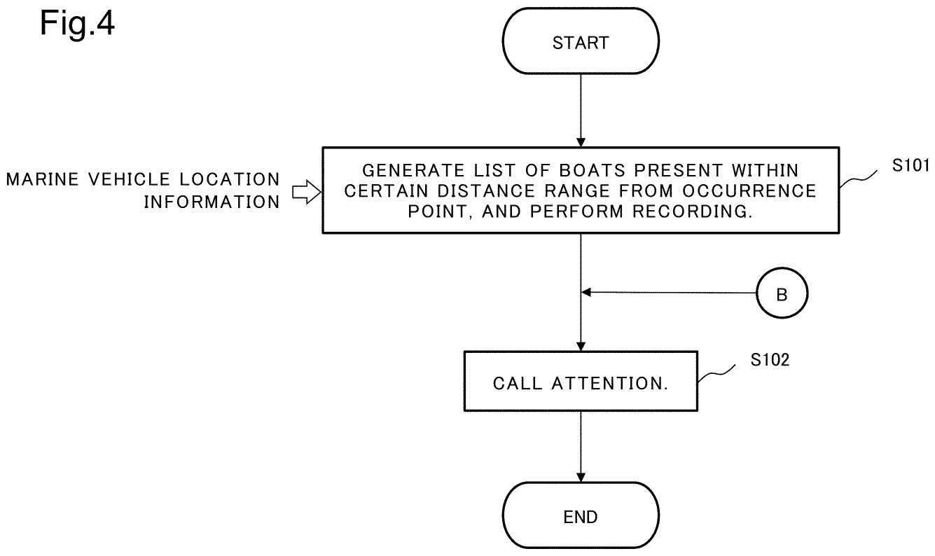

A first example shows a mechanism of automatically calling an attention of a marine vessel within an appropriate range through, for example, radio communication when it is detected that a moving staffed object (for example, a marine vessel) damages the submarine cable 10 subjected to protection and monitoring or performs an action having such risk. Description is made with reference to the conceptual diagram of FIG. 3 and the flowchart of FIG. 4.

In a method of calling an attention in the first example, an attention of a marine vessel is called when it is present within a certain distance range from a location in which an abnormal event is detected. For example, in FIG. 3, after an elapse of a certain time period from occurrence of an abnormal event, there are a boat B, a boat A, a boat C, and a boat D, which are stated in the order of closeness to the occurrence point. When a region indicated with a circle C2 having the occurrence point as a center is regarded as a warning range, the monitoring server 30 calls an attention of the boats A, B, and C, but does not issue a notification to the boat D.

A radius of the warning range is determined as three times of the water depth at the actual site, for example. Further, in this example, a region indicated with a circle C1 may be regarded as a warning range.

With reference to the flowchart of FIG. 4, an operation of the protection monitoring system 1 is described. When an abnormal event that is estimated to be caused by a marine vessel is detected, the monitoring server 30 generates a list of marine vessels that are present within a certain distance range from the abnormal event occurrence point, based on marine vessel location information data, and performs recording (S101). Further, the monitoring server 30 calls an attention of the listed marine vessels through, for example, radio communication (S102). B illustrated in FIG. 4 is described later.

For example, a message for calling an attention may be as follow. “Attention: the submarine cable 10 in the sea area you traveled at time (hour, minute) has detected a vibration indicating that an unknown object fell down on the sea bed near the geographical coordinates (latitude, longitude). If any failure occurs to the submarine cable, a marine vessel that caused the damage may receive a claim for the damage, and a sufficient attention should be paid.”

In a case in which an abnormal event having a risk is detected from the environment information such as a sound or a vibration, even when a failure is not caused in the submarine cable 10, such attention call is issued with a message according to a content thereof. Further, as illustrated in

FIG. 3, the notification range is limited to the marine vessels that travel or anchor within the certain range around a point at which the abnormal event having a risk is detected. In this manner, the protection monitoring system 1 prevents an excessively large number of warning notifications, and hence prevents habituation to the warning.

Further, when the warning implying that “when damage occurs, compensation for the damage may be demanded” is issued even though a failure does not occur to the submarine cable 10, a restraining effect can be exerted, and an effect of preventing a submarine cable failure can be expected.

### SECOND EXAMPLE

A second example is achieved by modifying a range of marine vessels for calling an attention. In this example, in addition to a location of a boat at the time of impact detection (a distance from the impact detection point), a recent track and a bow direction at the time of impact detection are regarded as factors. For example, an attention of a boat is called when the impact detection point is behind the boat and a track thereof is within a distance 1 from the impact detection point.

Herein, as for determination of whether the impact detection point is behind the boat, it is determined that the impact detection point is behind the boat when the failure detection point is present within a range from 60 degrees to 120 degrees while regarding the bow direction of the boat as a starting point, for example.

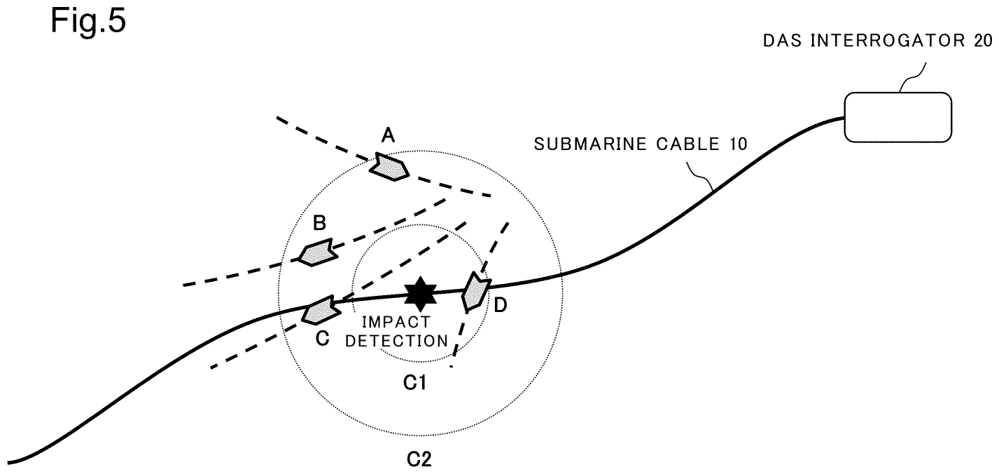

Under those conditions, each of the boats in FIG. 5 are examined. The impact detection point is not present behind the boat A. The track is from the distance 1 to a distance 2. An attention is not called.

The impact detection point is present behind the boat B. The track is from the distance 1 to the distance 2. An attention is not called.

The impact detection point is present behind the boat C. The track is within the distance 1. An attention is called.

The impact detection point is not present behind the boat D. The track is within the distance 1. An attention is not called.

In this manner, by adding a travel direction to the condition as described above, boats for calling an attention can further be narrowed down to highly suspicious ones, as compared to determination only with a distance from the impact detection point.

Note that, as a matter of course, an error in a location of a boat from the AIS should be taken into consideration, and in addition, updating of boat location information is intermittent, which remains a possibility that a sudden change in a bow direction or a speed cannot fully be grasped based on only one acquired piece of information. In view of this, it is desired that the bow direction be calculated from a recent track while considering the bow direction at the time of updating the location information. Further, it is also desired that the location of the boat be determined with a temporal margin in the track direction. For example, assuming that the boat D advances slightly further at the time of impact detection, the impact detection point may be behind the boat, and the boat may be a target for attention call.

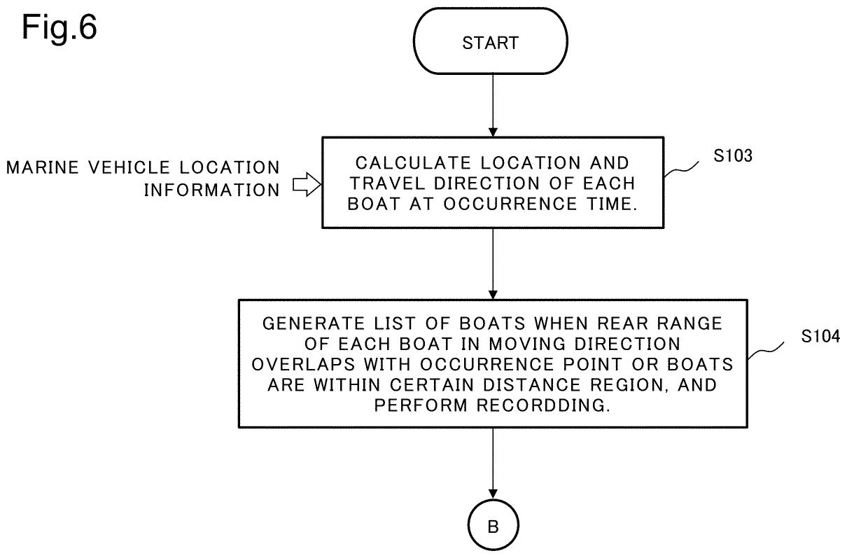

The flow is illustrated in FIG. 6. First, the monitoring server 30 calculates, from marine vessel location information data, a track of a boat in a periphery of an abnormal event occurrence point slightly back to an abnormal event occurrence time (S103). For example, in the processing of S103, the monitoring server 30 receives and holds information from a system such as the AIS that performs a notification of a location of a marine vessel at a regular interval, grasps locations of a boat at a plurality of times before the abnormal event occurrence time, and thus calculates a track. The monitoring server 30 generates a list of boats when a rear range with respect to a travel direction of each of the boats overlaps with the abnormal event occurrence point or the boats are within the certain distance range, and performs recording (S104). The subsequent flow is similar to attention call in the first example (proceed to B of FIG. 4).

In the first example, the warning is issued to a marine vessel within the certain distance range from the location in which the abnormal event is detected. In contrast, as in the second example, when estimation is performed back to the event occurrence time in consideration of a past track, a travel direction, and a moving speed, highly accurate estimation can be achieved, and hence habituation to the warning can further be prevented and a restraining effect can further be exerted.

As described above, the protection monitoring system 1 according to the first example embodiment performs an operation of calling an attention of a nearby marine vessel when an abnormal event having a risk of damaging the submarine cable 10 is detected. Herein, for example, when the abnormal event is classified as a noise and a vibration generated by a fishing tool scratching the bottom of the water while moving, a target for attention call can be narrowed down only to a fishing boat by acquiring information relating to a usage purpose of a boat from marine vessel location information data or the like. With this, habituation to the warning can further be prevented, and a restraining effect can further be exerted. In other words, according to the above-mentioned example embodiment, the protection monitoring system 1 can exert an effect of providing the protection monitoring system that includes the warning function causing less habituation to the warning and is capable of calling an attention at the time of detection of an abnormal vibration, which may or may not lead to a failure of the cable.

### SECOND EXAMPLE EMBODIMENT

In the first example embodiment, a main object is to prevent damage of the target object subjected to protection monitoring by performing appropriate attention call. In contrast, a second example embodiment provides a mechanism further involving automatic security and patrol actions when a failure incident that pauses a function occurs or an abnormal event regarded as intentional vandalism is detected. The protection monitoring system 1 according to the second example embodiment at least includes a configuration similar to that of the protection monitoring system 1 according to the first example embodiment.

The protection monitoring system 1 according to the second example embodiment includes an imaging means capable of capturing an image of a periphery of an abnormal event. When an abnormal event as described above is detected, a periphery there of is captured as an image. For example, an image may be captured by a flying warning device or drone on which a camera is mounted or a satellite on which a high-resolution camera is mounted. The image can be utilized as an evidence for an incident. In this manner, a warning device or a drone is an example of the imaging means.

Further, the protection monitoring system 1 includes a report means that reports to a public security department or a security company. When an abnormal event as described above is detected, a patrol boat or the like is dispatched to patrol the peripheral area. For example, more than a small number of marine vessels are not equipped with or do not activate an AIS transponder, and thus cannot be grasped with the AIS or the like. It is difficult to issue the warning to such marine vessels through radio communication, and hence it is required that a patrol boat or the like be dispatched to the actual site, confirm presence of such a marine vessel, and directly issue the warning.

Further, for example, an act for attempting to damage the target object subjected to protection monitoring can be stopped. In some cases, such an incident is caused by an action of a trader who collects and sells valuable metal from the bottom of the water.

Further, the protection monitoring system 1 according to the second example embodiment exerts effects similar to those exerted by the protection monitoring system 1 according to the first example embodiment.

### THIRD EXAMPLE EMBODIMENT

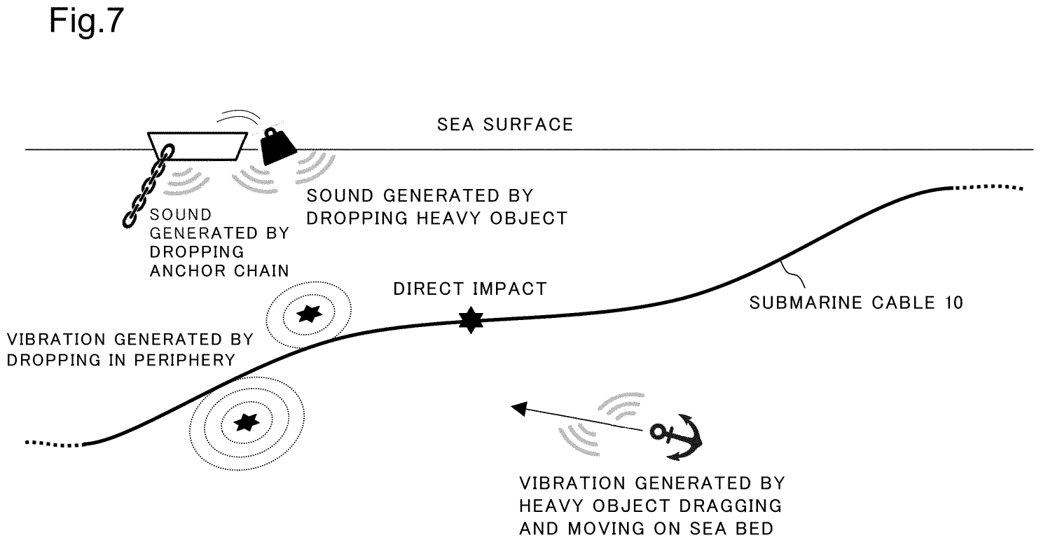

A third example embodiment takes the submarine cable 10 as an example, and description is made on a mechanism in which the protection monitoring system 1 classifies an abnormal event and performs a countermeasure according to a type thereof. Herein, description is made while including some of the countermeasures described in the first example embodiment and the second example embodiment. FIG. 7 illustrates, in a conceptual diagram, a typical abnormal event to be detected and dealt with. The protection monitoring system 1 according to the third example embodiment includes a configuration similar to that of the protection monitoring system 1 according to the second example embodiment.

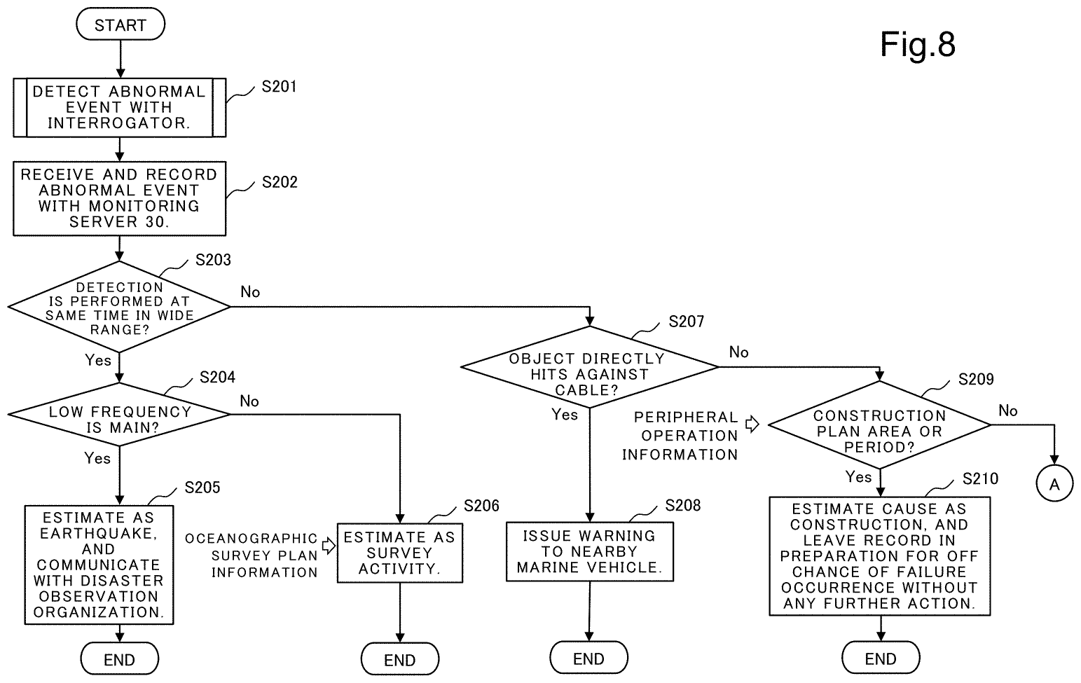

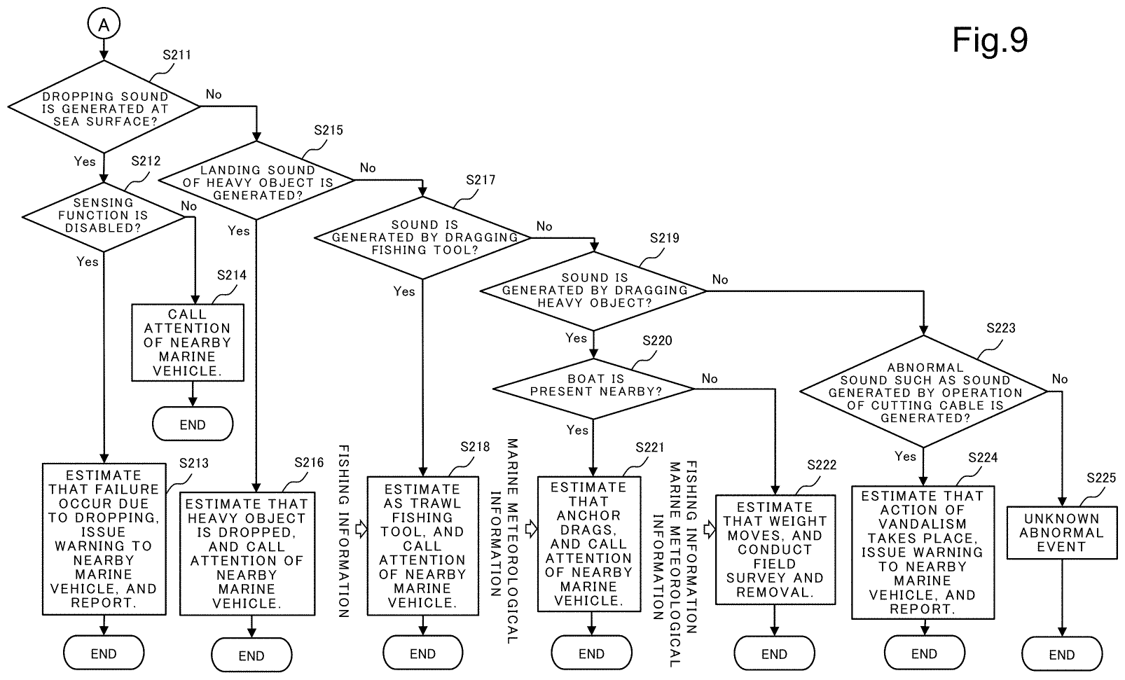

With reference to the flowcharts of FIG. 8 and FIG. 9, the protection monitoring system 1 according to the third example embodiment is described. First, the interrogator 20 detects and classifies an abnormal event (S201). An event that is classified to a harmless type in this step is not subjected to subsequent processing and is recorded as required, and the processing is completed. Examples of such an event include a sound generated by a fish finder or the like and a sound generated by a marine organism.

Subsequently, the monitoring server 30 receives and records abnormal event data in a data base (S202). The following processing is further executed.

Abnormal events detected at the same time in a wide range, which are possibly caused by earthquakes or artificial earthquakes by an underground resource exploration, are classified as an earthquake (S203). The monitoring server 30 performs classification according to characteristics indicating that, for example, a low frequency of a several Hz or lower is main (S204), and automatically notifies a disaster observation organization or the like of the data when it is estimated as an earthquake (S205). Further, when a low frequency is not main, it is estimated as a geological survey activity, and the processing is completed without any further step (S206).

In a case in which a local abnormal event is determined (S207), when an object hits against the submarine cable 10 (but a cable failure does not occur), the monitoring server 30 performs attention call or notification to a public security and patrol department or the like as described in the first example embodiment (S208).

Subsequently, the monitoring server 30 performs comparison with construction plan information (S209), estimates a construction as the cause at the time of matching, and completes the processing without any further step. The monitoring server 30 may leave a record in preparation for an off chance of failure occurrence (S210).

When the construction plan information does not match, the processing proceeds to A in FIG. 9.

When an abnormal event is classified into a sound generated by dropping an object onto the sea surface (S211), a sound generated by a heavy object landing on the sea bed (S215), a sound generated by dragging a fishing tool on the sea bed (S217), a sound generated by dragging a heavy object other than a fishing tool on the sea bed (S219), a sound generated by an operation for cutting a cable (S223), or the like, processing according to the type is automatically executed.

As illustrated in the conceptual diagram of FIG. 7, examples of the sound generated by dropping an object onto the sea surface (S211) include a sound generated by dropping, onto the sea, a heavy object having a risk of damaging the submarine cable 10 (for example, an anchor or a weight of a large-sized marine vessel, or an illegally abandoned object) and a contact sound of an anchor chain with a boat body at the time of laying out the anchor from the boat (windlass operation sound). Even when a sound is generated near the sea surface, a large sound propagates in the water, and is detected by the submarine cable 10.

When a vibration generated by a heavy object landing on the sea bed is detected after a sound generated by dropping the heavy object onto the sea is detected in the processing of S211, the monitoring server 30 is capable of determining more reliably that something is dropped from a boat. Moreover, even when the heavy object directly hits against the submarine cable 10 to immediately cause a failure and disable a sensing function (S212), the monitoring server 30 is capable of acquiring an abnormal event occurrence location and a time, based on the sound of dropping the heavy object onto the sea, and executing processing of reporting for security and patrol described in the second example embodiment (S213). This is an advantageous point provided when an abnormal sound generated near the sea surface is additionally subjected to classification and monitoring.

Even when the submarine cable 10 is not hit against (“No” for the conditional branch in S212), it is dangerous to lay out an anchor in the periphery, and hence a notification for calling an attention described in the first example embodiment is issued (S214).

Next, as described in the first example embodiment, in a case of the sound generated by a heavy object landing on the sea bed (S215), the monitoring server 30 calls an attention of a nearby marine vessel (S216). As described in the first example embodiment, in a case of the sound generated by dragging a fishing tool (S217), the monitoring server 30 narrows down a target, and calls an attention of a fishing boat (S218).

In a case of the sound generated by dragging a heavy object other than a fishing tool on the sea bed (S219), when a boat is present nearby (S220), and it is estimated that an anchor drags in addition to evaluation on maritime meteorological information, the monitoring server 30 calls an attention (S221) as described in the first example embodiment. Herein, a situation where an anchor drags is caused when an anchor or a weight laying out on the sea bed does not function and moves on the bottom of the water while dragging from a boat. When there is no boat nearby, a weight of a buoy or a floating fishing bank possibly moves due to stormy weather or a strong tide, and hence the monitoring server 30 issues a notification for requesting a field survey and actions for prevention and elimination to a security company or the like (S222).

When an act of vandalism such as a sound generated by an operation for cutting a cable or a sound generated by a salvage operation from the sea bed is detected (S223), the monitoring server 30 issues the warning to a nearby marine vessel and reports, as described above in the second example embodiment (S224).

It is desired that the data primary processing unit 22 include abnormal event classification conditions that enable event classification for various types of abnormal events as described above with sufficient estimation accuracy. When an amount of case data for learning characteristics is small, it is desired that preparation be done by causing an event in an artificial and simulating manner with respect to the actual submarine cable 10 and collecting sensing data.

Further, the protection monitoring system 1 according to the third example embodiment exerts effects similar to those exerted by the protection monitoring system 1 according to the first example embodiment.

### MODIFICATION EXAMPLE

In the first example embodiment to the third example embodiment, description is made while giving DAS as an example of the optical fiber sensing method, and other methods such as DVS, DTS, and BOTDR may be adopted. Herein, DVS is an abbreviation form of distributed vibration sensing, DTS is an abbreviation form of distributed temperature sensing, and BOTDR is an abbreviation form of Brillouin optical time-domain reflectometry.

Moreover, there may be adopted optical fiber sensing other than an OTDR type, which enables sensing in a widely distributed manner. For example, PTL 5 and NPL 3 disclose a distribution-type optical fiber sensing technique using transmitted light in place of an OTDR type using reflected return light.

Needless to say, the first example embodiment to the third example embodiment, which are described with an example of the submarine cable under operation, may be applied to a laid cable section during a cable laying construction period or a period during which a service operation is inactive.

The first example embodiment to the third example embodiment, which are described with an example in of the cable used under the sea, may be applied to usage in a river, a lake, or a swamp.

The first example embodiment to the third example embodiment are mainly described with an example of the communication submarine cable, and a submarine power cable including an optical fiber or a submarine pipeline along which an optical fiber extends may be subjected to monitoring according to the present disclosure.

The first example embodiment to the third example embodiment, which are described with an example of the cable used in the water, may also applied similarly to an underground cable, an aerial cable, and the like.

The first example embodiment to the third example embodiment are described with an example of using optical fiber sensing as the means for detecting a sound or a vibration sensed by the submarine cable, but a sound or a vibration sensor element embedded in a submarine device may be included and detection may be performed thereby.

The first example embodiment to the third example embodiment are described with an example of monitoring based on a sound or a vibration phenomenon as environment information sensed by the submarine cable, but a change in temperature may be adopted, for example.

### FOURTH EXAMPLE EMBODIMENT

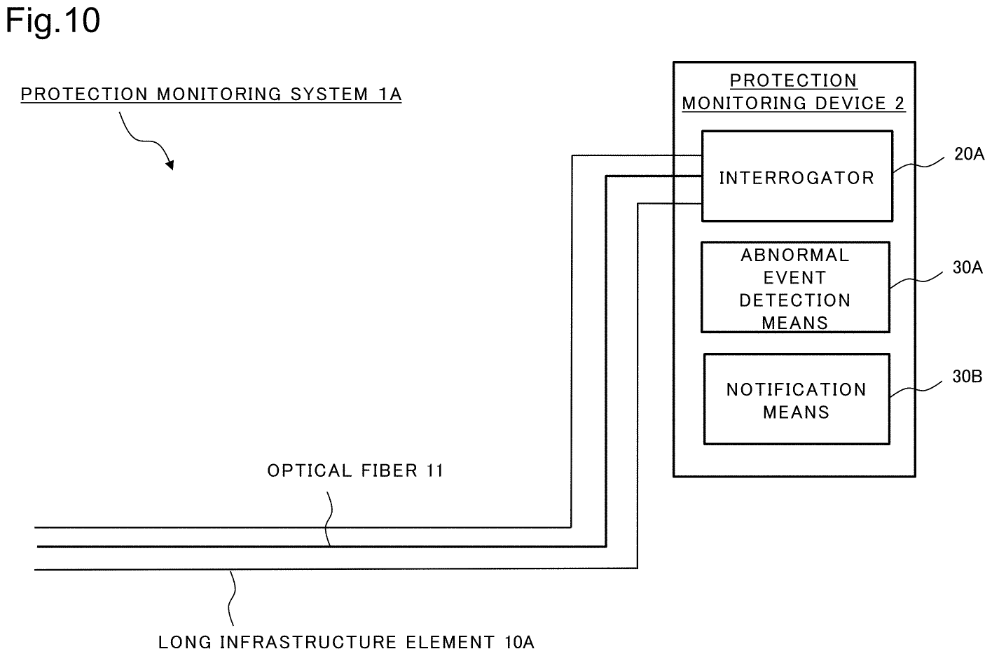

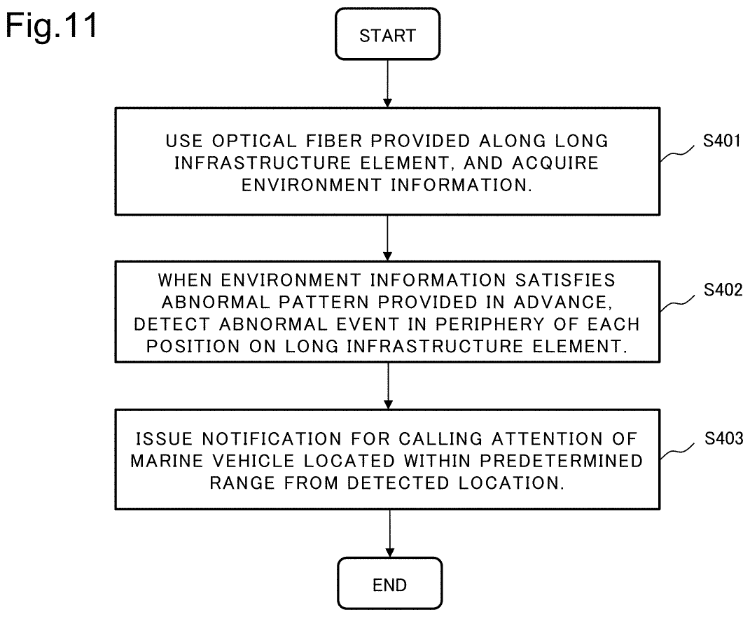

A protection monitoring system 1A according to a fourth example embodiment is described with reference to FIG. 10 and FIG. 11. FIG. 10 is a block diagram illustrating a configuration example of the protection monitoring system 1A. As illustrated in FIG. 10, the protection monitoring system 1A includes the optical fiber 11, the interrogator 20A, an abnormal event detection means 30A, and a notification means 30B. The abnormal event detection means 30A may be achieved by the data primary processing unit 22 described in the first example embodiment to the third example embodiment. Further, the notification means 30B may be achieved by the monitoring server 30 described in the first example embodiment to the third example embodiment.

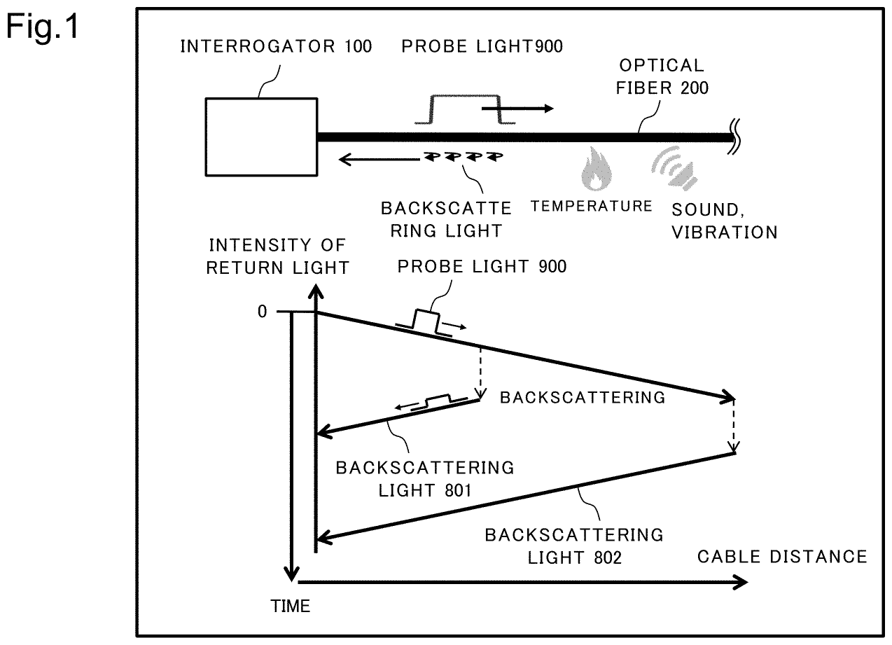

The optical fiber 11 is provided along a long infrastructure element 10A installed in the water or on the bottom of the water. Note that the optical fiber 11 may be accommodated inside the long infrastructure element 10A as illustrated in FIG. 1. Further, the interrogator 20A uses the optical fiber, and thus acquires environment information at each position on the long infrastructure element 10A. Further, when the environment information acquired at each position on the long infrastructure element 10A matches with an abnormal pattern provided in advance, the abnormal event detection means 30A detects an abnormal event in a periphery of each position on the long infrastructure element 10A. Further, the notification means 30B issues a notification for calling an attention of a marine vessel located within a predetermined range from an abnormality occurrence location. The configuration of the protection monitoring system 1A is as described above.

Next, description is made on an operation of the protection monitoring system 1A with reference to FIG. 11. FIG. 11 is a flowchart illustrating an operation of the protection monitoring system.

First, the interrogator 20A uses the optical fiber provided along the long infrastructure element, and thus acquires environment information (S401). Further, when the environment information acquired at each position on the long infrastructure element 10A matches with an abnormal pattern provided in advance, the abnormal event detection means 30A detects an abnormal event in a periphery of each position on the long infrastructure element (S402). Further, the notification means 30B issues a notification for calling an attention of a marine vessel located within a predetermined range from a detected location (S403).

As described above, when abnormality is detected in the long infrastructure element itself or in the periphery thereof, the protection monitoring system 1A according to the fourth example embodiment issues a notification for calling an attention of a marine vessel. Thus, for example, when an abnormal event having a risk of damaging the long infrastructure element 10A is detected, the protection monitoring system 1 is capable of performing an operation of calling an attention of a nearby marine vessel.

Herein, for example, when an abnormal event is classified as a sound or a vibration generated by a fishing tool scratching the bottom of the water while moving, information relating to a usage purpose of a boat is also acquired from marine vessel location information data or the like, and thus a target for attention call can be narrowed down only to a fishing boat. With this, habituation to the warning can further be prevented, and a restraining effect can further be exerted. In other words, according to the above-mentioned example embodiment, the protection monitoring system 1A can exert an effect of providing the protection monitoring system that includes the warning function causing less habituation to the warning and is capable of calling an attention at the time of detection of an abnormal vibration, which may or may not lead to a failure of the cable.

Note that a part or an entirety of each of the example embodiments described above may be described as in the following supplementary notes, however, is not limited thereto.

### (Supplementary Note 1)

A protection monitoring system including:
an optical fiber being provided along a long infrastructure element installed in water or a bottom of water;
an interrogator that acquires environment information at each of positions on the long infrastructure element through use of the optical fiber;
abnormal event detection means for detecting an abnormal event in a periphery of the each position when the environment information acquired at the position satisfies an abnormal pattern provided in advance; and
notification means for issuing a notification for calling an attention of a marine vessel located within a predetermined range from the position at which the abnormal event is detected.

### (Supplementary Note 2)

The protection monitoring system according to Supplementary Note 1, wherein
the abnormal event detection means corrects a sensitivity degree for sensing the environment information for each of the positions on the long infrastructure element, and then attempts to detect the abnormal pattern.

### (Supplementary Note 3)

The protection monitoring system according to Supplementary Note 1 or 2, wherein
the abnormal event detection means divides the environment information to frequency bands, and then attempts to detect the abnormal pattern.

### (Supplementary Note 4)

The protection monitoring system according to any one of Supplementary Notes 1 to 3, wherein
when the abnormal event detection means classifies the environment information, and then a type of the abnormal event is a type that is possibly generated at a location away from the long infrastructure element, the abnormal event detection means collectively outputs identical abnormal events as one abnormal event, the identical abnormal events being detected at a plurality of the positions on the long infrastructure element.

### (Supplementary Note 5)

The protection monitoring system according to any one of Supplementary Notes 1 to 4, wherein,
when the abnormal event detection means classifies the environment information, and a type of the abnormal event is a type whose occurrence point is likely to move, the abnormal event detection means applies a moving model, and tracks the occurrence point of the abnormal event.

### (Supplementary Note 6)

The protection monitoring system according to any one of Supplementary Notes 1 to 5, further including:
marine vessel location information acquisition means for acquiring navigation history of a marine vessel in a water area in a periphery of the long infrastructure element, wherein
the notification means calls an attention of only a marine vessel that is highly likely to cause the abnormal event, based on a location and a travel direction of a marine vessel at a time when the abnormal event occurs.

### (Supplementary Note 7)

The protection monitoring system according to any one of Supplementary Notes 1 to 6, wherein,
when the notification means classifies the abnormal event as a type caused by a fishing tool hitting against a bottom of water, the notification means issues a notification for calling an attention of only a fishing boat among marine vessels within a water area in a periphery of the long infrastructure element.

### (Supplementary Note 8)

The protection monitoring system according to any one of Supplementary Notes 1 to 7, further including:
imaging means for capturing an image of a periphery, wherein the imaging means captures an image of a periphery of a location in which the abnormal event occurs.

### (Supplementary Note 9)

The protection monitoring system according to any one of Supplementary Notes 1 to 8, wherein
the notification means issues a notification to a public security department or a security company in such a way as to patrol a periphery of a location in which the abnormal event occurs.

### (Supplementary Note 10)

The protection monitoring system according to Supplementary Note 9, wherein,
when the notification means classifies the abnormal event as a type caused by an act of damaging the long infrastructure element, the notification means issues a notification to a public security department or a security company.

### (Supplementary Note 11)

The protection monitoring system according to any one of Supplementary Notes 1 to 10, wherein
the abnormal event is a sound or a vibration being generated by a contact of an object with the long infrastructure element, dropping of an object onto a bottom of water near the long infrastructure element, dragging of a heavy object on a bottom of water near the long infrastructure element, or an action of damaging the long infrastructure element.

### (Supplementary Note 12)

The protection monitoring system according to any one of Supplementary Notes 1 to 10, wherein
the abnormal event is a sound or a vibration being generated by any one of dropping of a heavy object onto a water surface near the long infrastructure element and paying-out of an anchor chain onto a water surface near the long infrastructure element.

### (Supplementary Note 13)

The protection monitoring system according to any one of Supplementary Notes 1 to 12, wherein,
when the abnormal event detection means detects a sound generated by dropping an object onto a water surface, and the environment information is not acquired from the optical fiber, the abnormal event detection means detects a failure due to dropping of the object, and
the notification means issues a notification for calling an attention of a marine vessel located within a predetermined range from a location in which the abnormal event occurs.

### (Supplementary Note 14)

The protection monitoring system according to any one of Supplementary Notes 1 to 13, wherein
when the abnormal event detection means detects a sound generated by dropping an object onto a water surface, and the environment information is acquired from the optical fiber, the abnormal event detection means detects dropping of the object as an abnormal event, and
the notification means issues a notification for calling an attention of a marine vessel located within a predetermined range from a location in which the abnormal event occurs.

### (Supplementary Note 15)

A protection monitoring device including:
an interrogator that acquires environment information at each of positions on a long infrastructure element installed in water or a bottom of water through use of an optical fiber provided along the long infrastructure element;
abnormal event detection means for detecting an abnormal event in a periphery of the each position when the environment information acquired at the position satisfies an abnormal pattern provided in advance; and
notification means for issuing a notification for calling an attention of a marine vessel located within a predetermined range from the position at which the abnormal event is detected.

### (Supplementary Note 16)

A protection monitoring method including:
acquiring environment information at each of positions on a long infrastructure element installed in water or a bottom of water through use of an optical fiber provided along the long infrastructure element;
detecting an abnormal event in a periphery of the each position when the environment information acquired at the position satisfies an abnormal pattern provided in advance; and
issuing a notification for calling an attention of a marine vessel located within a predetermined range from the position at which the abnormal event is detected.

### (Supplementary Note 17)

A storage medium storing a protection monitoring program causing an information processing device to execute:
processing of acquiring environment information at each of positions on a long infrastructure element installed in water or a bottom of water through use of an optical fiber provided along the long infrastructure element;
processing of detecting an abnormal event in a periphery of the each position when the environment information acquired at the position satisfies an abnormal pattern provided in advance; and
processing of issuing a notification for calling an attention of a marine vessel located within a predetermined range from the position at which the abnormal event is detected.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-111523, filed on Jun. 29, 2020, the disclosure of which is incorporated herein in its entirety by reference.

### REFERENCE SIGNS LIST

1 Protection monitoring system
10 Submarine cable
11 Optical fiber
20 DAS interrogator
21 Sensing function unit
22 Data primary processing unit
30 Monitoring server

What is claimed is:

1. A protection monitoring system comprising:
an optical fiber being provided along a long infrastructure element installed in water or a bottom of water;
an interrogator configured to acquire environment information at each of positions on the long infrastructure element through use of the optical fiber;
an abnormal event detector configured to detect an abnormal event in a periphery of the each position when the environment information acquired at the position satisfies an abnormal pattern provided in advance; and
a notificator configured to issue a notification for calling an attention of a marine vehicle located within a predetermined range from the position at which the abnormal event is detected.

2. The protection monitoring system according to claim 1, wherein
the abnormal event detector corrects a sensitivity degree for sensing the environment information for each of the positions on the long infrastructure element, and then attempts to detect the abnormal pattern.

3. The protection monitoring system according to claim 1, wherein
the abnormal event detector divides the environment information to frequency bands, and then attempts to detect the abnormal pattern.

4. The protection monitoring system according to claim 1, wherein,
when the abnormal event detector classifies the environment information, and then a type of the abnormal event is a type that is possibly generated at a location away from the long infrastructure element, the abnormal event detector collectively outputs identical abnormal events as one abnormal event, the identical abnormal events being detected at a plurality of the positions on the long infrastructure element.

5. The protection monitoring system according to claim 1, wherein,
when the abnormal event detector classifies the environment information, and a type of the abnormal event is a type whose occurrence point is likely to move, the abnormal event detector applies a moving model, and tracks the occurrence point of the abnormal event.

6. The protection monitoring system according to claim 1, further comprising:
a marine vehicle location information acquisitor configured to acquire navigation history of a marine vehicle in a water area in a periphery of the long infrastructure element, wherein
the notificator calls an attention of only a marine vehicle that is highly likely to cause the abnormal event, based on a location and a travel direction of a marine vehicle at a time when the abnormal event occurs.

7. The protection monitoring system according to claim 1, wherein,
when the notificator classifies the abnormal event as a type caused by a fishing tool hitting against a bottom of water, the notifiactor issues a notification for calling an attention of only a fishing boat among marine vehicles within a water area in a periphery of the long infrastructure element.

8. The protection monitoring system according to claim 1, further comprising:
an imager configured to capture an image of a periphery, wherein
the imager captures an image of a periphery of a location in which the abnormal event occurs.

9. The protection monitoring system according to claim 1, wherein
the notificator issue a notification to a public security department or a security company in such a way as to patrol a periphery of a location in which the abnormal event occurs.

10. The protection monitoring system according to claim 9, wherein,
when the notificator classifies the abnormal event as a type caused by an act of damaging the long infrastructure element, the notificator issues a notification to a public security department or a security company.

11. The protection monitoring system according to claim 1, wherein
the abnormal event is a sound or a vibration being generated by a contact of an object with the long infrastructure element, dropping of an object onto a bottom of water near the long infrastructure element, dragging of a heavy object on a bottom of water near the long infrastructure element, or an action of damaging the long infrastructure element.

12. The protection monitoring system according to claim 1, wherein
the abnormal event is a sound or a vibration being generated by any one of dropping of a heavy object onto a water surface near the long infrastructure element and paying-out of an anchor chain onto a water surface near the long infrastructure element.

13. The protection monitoring system according to claim 1, wherein,
when the abnormal event detector detects a sound generated by dropping an object onto a water surface, and the environment information is not acquired from the optical fiber, the abnormal event detector detects a failure due to dropping of the object, and
the notificator issues a notification for calling an attention of a marine vehicle located within a predetermined range from a location in which the abnormal event occurs.

14. The protection monitoring system according to claim 1, wherein,
when the abnormal event detector detects a sound generated by dropping an object onto a water surface, and the environment information is acquired from the optical fiber, the abnormal event detector detects dropping of the object as an abnormal event, and
the notificator issues a notification for calling an attention of a marine vehicle located within a predetermined range from a location in which the abnormal event occurs.

15. (canceled)

16. A protection monitoring method comprising:
acquiring environment information at each of positions on a long infrastructure element installed in water or a bottom of water through use of an optical fiber provided along the long infrastructure element;
detecting an abnormal event in a periphery of the each position when the environment information acquired at the position satisfies an abnormal pattern provided in advance; and
issuing a notification for calling an attention of a marine vehicle located within a predetermined range from the position at which the abnormal event is detected.

17. A storage medium storing a protection monitoring program causing an information processing device to execute:
processing of acquiring environment information at each of positions on a long infrastructure element installed in water or a bottom of water through use of an optical fiber provided along the long infrastructure element;
processing of detecting an abnormal event in a periphery of the each position when the environment information acquired at the position satisfies an abnormal pattern provided in advance; and
processing of issuing a notification for calling an attention of a marine vehicle located within a predetermined range from the position at which the abnormal event is detected.
